(19) United States
(12) Patent Application Publication
(10) Pub. No.: US 2026/0254215 A1
(43) Pub. Date: Aug. 27, 2026

(54) COVER UNIT

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP)

(72) Inventors: Kiyofumi KAWAGUCHI, Yokkaichi-shi (JP); Haruki OKANO, Yokkaichi-shi (JP)

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP)

(21) Appl. No.: 19/544,819

(22) Filed: Feb. 19, 2026

(30) Foreign Application Priority Data
Feb. 25, 2025 (JP) 2025-027883

(51) Int. Cl. H02G 3/08

(52) U.S. Cl. CPC H02G 3/081

(57) ABSTRACT

Provided is a technique for stably holding a supported body in an upright posture relative to a base body. A cover unit includes a base body; and a supported body. The supported body has a supported portion and is rotatable about the supported portion between an upright state and a prone state relative to the base body. The supported body is provided with a protrusion, and the base body is provided with a recess that restricts rotation of the supported body from the upright state to the prone state by fitting the protrusion therein in the upright state.

### CROSS-REFERENCE TO RELATED APPLICATIONS

This application claims priority of Japanese Patent Application No. JP 2025-027883 filed on February 25, 2025, the content of which is incorporated herein.

### TECHNICAL FIELD

The present disclosure relates to a cover unit.

### BACKGROUND

JP H7-222330A discloses a cover (supported body) that covers a fuse housing portion formed in an electrical junction box (base body). This cover is rotatably mounted on a shaft provided in the electrical junction box, and can hold the fuse housing portion in a closed state.

JP H7-222330A is an example of related art.

### SUMMARY

The cover in JP H7-222330A appears to be rotatable 180 degrees about a shaft from the closed state. For example, if the cover can be held in an upright posture and the rotation range can be kept under 180 degrees, it is possible to arrange other components in a space facing a back surface of the cover, which can help to reduce the size of the structure around the electrical junction box. In this case, a structure capable of holding the cover in the upright posture is required.

The present disclosure has been made in view of the foregoing circumstances, and an object of the present disclosure is to provide a technique for stably holding a supported body in an upright posture relative to a base body.

A cover unit of the present disclosure a cover unit comprising:

a base body; and

a supported body,

wherein the supported body has a supported portion and is rotatable about the supported portion between an upright state and a prone state relative to the base body, and

one of the supported body and the base body is provided with a protrusion, and the other of the supported body and the base body is provided with a recess that restricts rotation of the supported body from the upright state to the prone state by fitting the protrusion therein in the upright state.

According to the present disclosure, a supported body can be stably held in an upright posture relative to a base body.

### BRIEF DESCRIPTION OF THE DRAWINGS

FIG. 1 is an exploded perspective view of an electrical junction box including a cover unit according to Embodiment 1;

FIG. 2 is an enlarged perspective view of a main part showing an upright portion and a back support portion of a base body;

FIG. 3 is a perspective view showing a supported body;

FIG. 4 is a side view showing a state in which a supported body is arranged above a base body;

FIG. 5 is a side view showing a state in which the supported body is attached to the base body;

FIG. 6 is a side view showing a state in which the supported body is in contact with the back support portion;

FIG. 7 is a front view showing a state in which the supported body is attached to the base body; and

FIG. 8 is a side view showing a state in which the supported body is disposed in a prone state relative to the base body.

### DETAILED DESCRIPTION OF PREFERRED EMBODIMENTS

First, embodiments of the present disclosure will be listed and described.

A cover unit of the present disclosure includes: (1) a base body; and a supported body, wherein the supported body has a supported portion and is rotatable about the supported portion between an upright state and a prone state relative to the base body, and one of the supported body and the base body is provided with a protrusion, and the other of the supported body and the base body is provided with a recess that restricts rotation of the supported body from the upright state to the prone state by fitting the protrusion therein in the upright state.

According to the present disclosure, a supported body can be stably held in an upright posture relative to a base body.

According to (1) above, due to the protruding portion fitting into the recess, it is possible to suppress the rotation of the supported body from the upright state to the prone state, and it is possible to bring the supported body into the prone state due to the protruding portion separating from the recess. Here, “the upright state" refers to a state in which the protruding portion is fitted into the recess and the supported body rises upward from the base body, and “the prone state” refers to a state in which the supported body lies along the upper surface of the base body.

(2) In the cover unit according to (1) above, it is preferable that the base body includes: a pedestal; an upright portion protruding from the pedestal; and

a supporting portion that is provided at the upright portion and supports the supported portion, and the one of the recess and the protrusion that is provided on the base body is provided between the supporting portion and the pedestal in a direction in which the upright portion protrudes.

According to (2) above, it is possible to prevent the recess and the protruding portion from being located away from the pedestal in the direction in which the upright portion protrudes, and the configuration can be made small.

(3) In the cover unit according to (3) above, it is preferable that the supported body in the upright state is open more than 90 degrees from the prone state, and a back surface of the supported body is disposed at an acute angle relative to a seat surface of the pedestal, and the base body includes a back support portion that supports the back surface of the supported body in the upright state.

According to (3) above, the back support portion makes it easy to stably hold the posture of the supported body in the upright state.

(4) In the cover unit according to (3) above, it is preferable that the back support portion has an inclined surface that is inclined along the back surface of the supported body in the upright state.

According to (4) above, the back support portion can come into face contact with the back surface of the supported body, and stress generated when coming into contact with the back surface of the supported body can be dispersed on the inclined surfaces.

(5) In the cover unit according to any one of (1) to (4) above, it is preferable that the supported body includes a protruding portion that extends in one direction and is capable of elastically deforming, and the protrusion is provided at a leading end portion in the one direction of the protruding portion, and is detachably locked to the recess.

According to (5) above, the projecting portion can be elastically deformed, and the protruding portion is provided at the leading end portion in the direction in which the projecting portion, thus making it easy to smoothly fit and separate the protruding portion and the recess.

Specific examples of embodiments of the present disclosure will be described below with reference to the drawings. Note that the present disclosure is not limited to this example, but is indicated by the scope of the claims, and all changes that come within the same essential spirit as the scope of the claims are intended to be embraced therein.

Embodiment 1

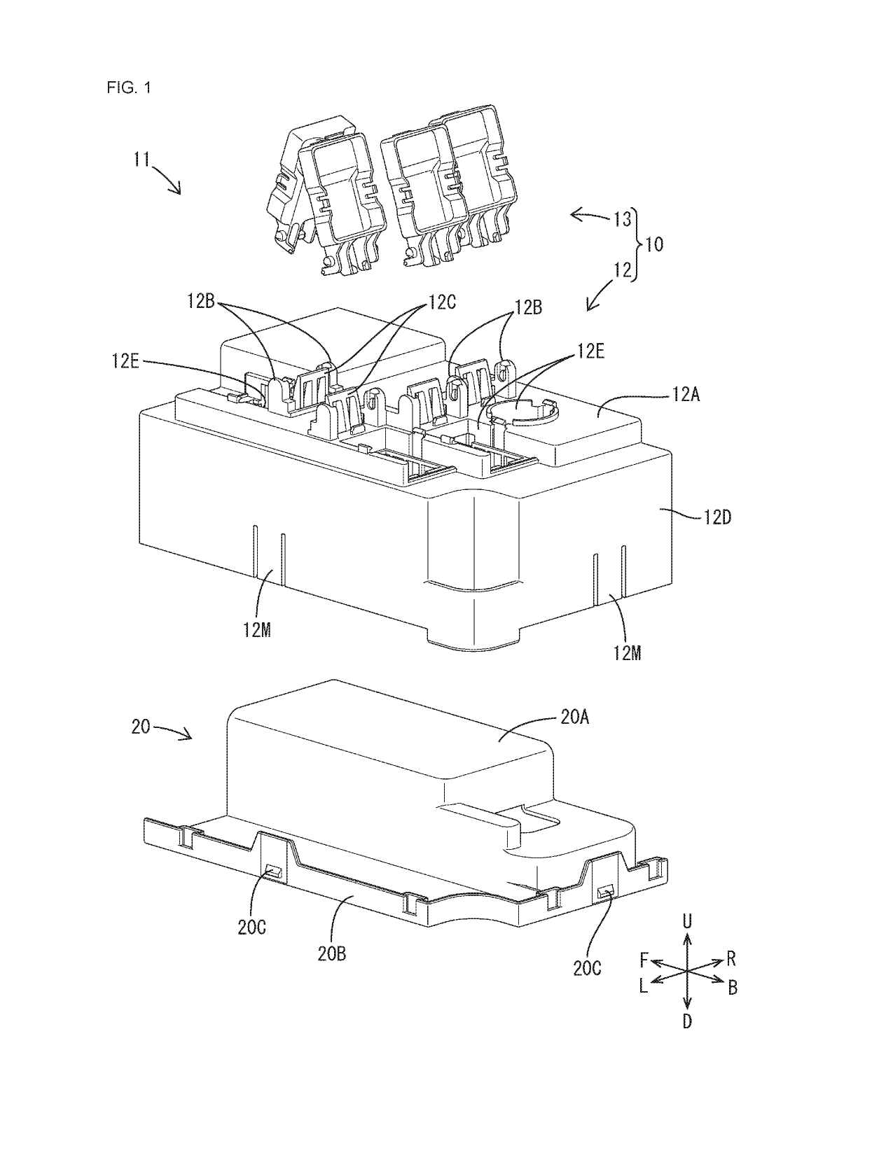

A specific example of Embodiment 1 will be described with reference to FIGS. 1 to 8. A cover unit 10 according to Embodiment 1 is used in, for example, an electrical junction box 11 to be mounted in a vehicle such as an electric vehicle. In the figure, "front side", "rear side", "upper side", "lower side", "right side" and "left side" refer to "F", "B", "U", "D", "R", and "L", respectively. It should be noted that the reference of the directions is defined for convenience, and these directions do not necessarily coincide with the directions in a state in which the electrical junction box 11 provided with the cover unit 10 is mounted in a vehicle or the like. For example, the up-down direction is not limited to the gravitational direction.

### Configuration of Electrical Junction Box

The electrical junction box 11 shown in FIG. 1 accommodates electric components such as relays and registers, bus bars, and the like (not shown). The electrical junction box 11 includes a case 20 and the cover unit 10. The electrical junction box 11 shown in FIG. 1 is illustrated by cutting out its main part.

The case 20 is made of a synthetic resin. In Embodiment 1, the case 20 is a lower case. The case 20 includes an attachment wall portion 20A and a peripheral wall portion 20B that rises so as to surround the attachment wall portion 20A. Electronic components such as relays and registers, bus bars, and the like (not shown) are attached to and fixed to the attachment wall portion 20A of the case 20.

In Embodiment 1, the cover unit 10 is an upper case. The cover unit 10 includes a base body 12 and a plurality of supported bodies 13.

### Configuration of Base Body

The base body 12 is made of a synthetic resin. The base body 12 includes: a pedestal 12A whose plate thickness direction is oriented in the up-down direction; a hanging wall portion 12D that is continuous with and hangs down from the outer circumferential edge portion of the pedestal 12A; a plurality of upright portions 12B; and a plurality of back support portions 12C. The base body 12 has a box-like shape that is open downward.

The pedestal 12A is provided with a plurality of through holes 12E that extend through in the plate thickness direction. In Embodiment 1, the plurality of through holes 12E have openings formed in a rectangular or circular shape.

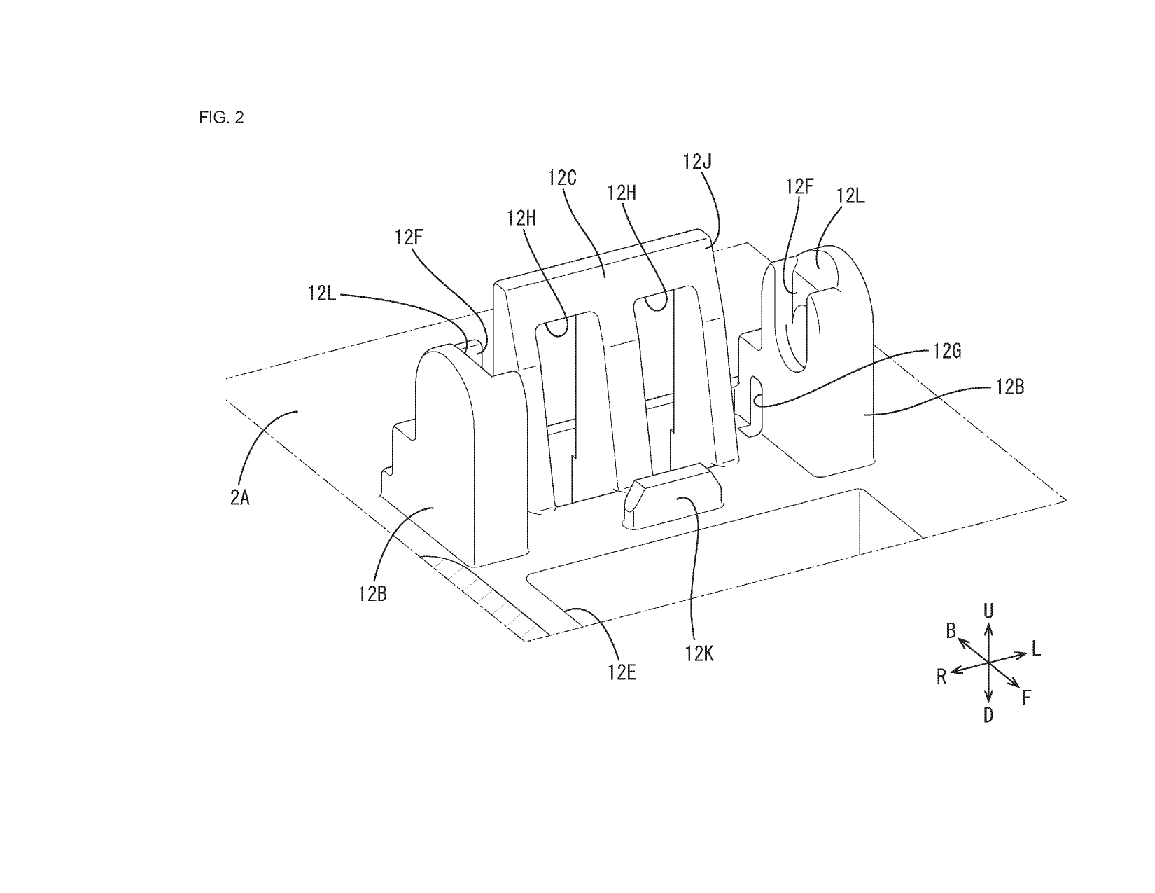

As shown in FIG. 2, the upright portions 12B and the back support portions 12C rise and protrude from the pedestal 12A. The plurality of upright portions 12B and the back support portions 12C are provided in correspondence with the through holes 12E. Specifically, each pair of upright portions 12B are arranged so as to sandwich the corresponding back support portion 12C from the outside in the left-right direction. Each pair of upright portions 12B and the back support portion 12C are disposed along the edge of the corresponding through hole

12E. Each pair of upright portions 12B sandwich the corresponding back support portion 12C. Each back support portion 12C is sandwiched between the corresponding pair of upright portions 12B.

Each of the upright portions 12B is provided with a supporting portion 12F and a recess 12G. Each supporting portion 12F is formed so as to be recessed downward at an upper portion (leading end portion in a projecting direction) of the upright portion 12B. In each of the upright portions 12B, the supporting portion 12F is open inward in the left-right direction in a direction facing the back support portion 12C. The recess 12G is formed in a lower portion (base end portion in the projecting direction) of each upright portion 12B. In other words, the recesses 12G are provided between the supporting portions 12F and the pedestal 12A in the projecting direction of the upright portion 12B (up-down direction). In each of the upright portions 12B, the recess 12G is recessed outward in the left-right direction (in a direction away from the back support portion 12C) on a surface facing inward in the left-right direction (a surface facing the back support portion 12C).

The back support portion 12C is formed to be wide in the left-right direction (the direction in which the pair of upright portions 12B are lined up). The back support portion 12C is provided with two insertion holes 12H that extend through the back support portion 12C in the front-rear direction orthogonal to the left-right direction. A side surface of the back support portion 12C, facing the through hole 12E side, is formed as an inclined surface 12J that is inclined so as to gradually become away from the through hole 12E in a plate surface direction of the pedestal 12A toward the upper end (leading end in the projecting direction) of the back support portion 12C. That is, the back support portion 12C has the inclined surface 12J. The pedestal 12A between the back support portion 12C and the through hole 12E is provided with a projecting portion 12K that protrudes upward.

### Structure of Supported Body

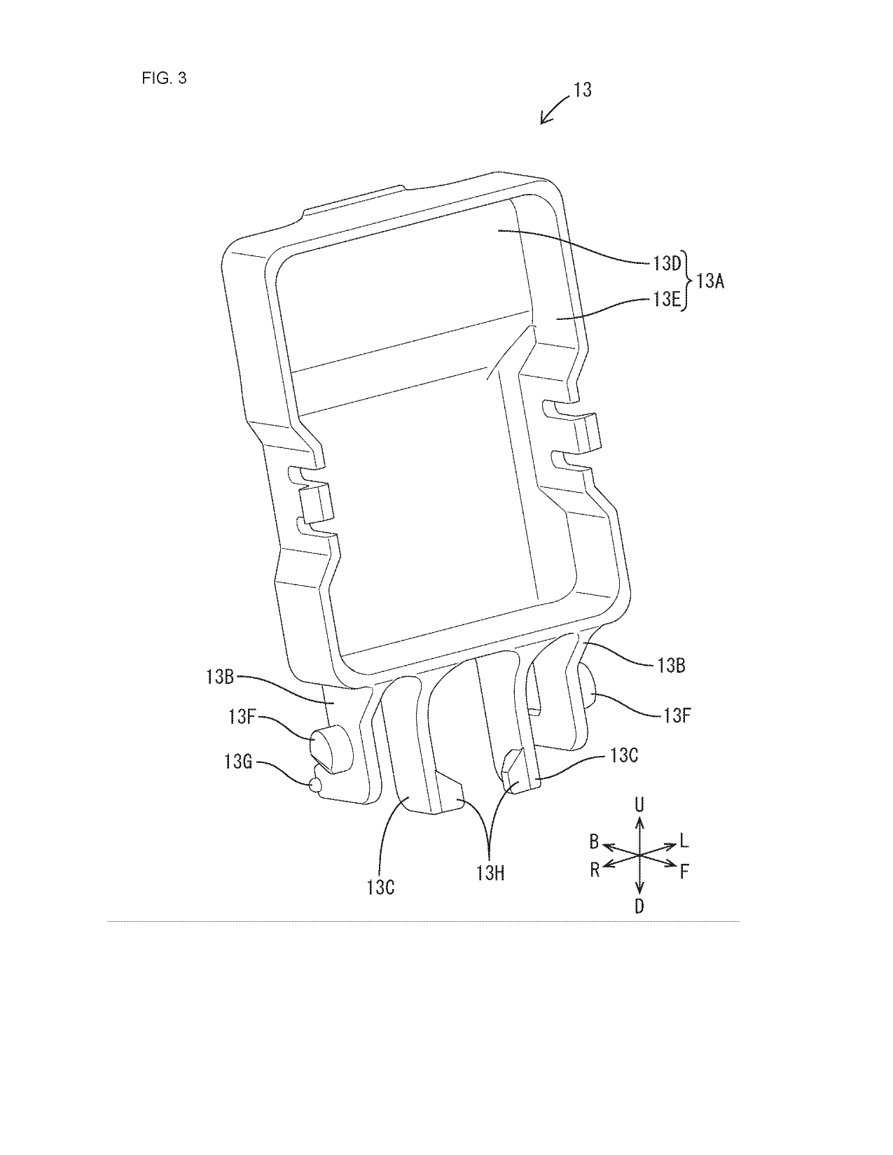

As shown in FIG. 3, each of the plurality of supported bodies 13 includes a closing portion 13A, a pair of protruding portions 13B, and a pair of extending portions 13C. The supported bodies 13 is made of a synthetic resin, for example. In the following description of

the supported body 13, the side facing the through hole 12E is referred to as the front side based on the upright state. The closing portion 13A includes a closing wall portion 13D that has a substantially flat rectangular plate shape and an annular wall portion 13E that extends from the outer circumferential edge portion of the closing wall portion 13D in the plate thickness direction of the closing wall portion 13D.

The two protruding portions 13B extend from the respective two end portions in the left-right direction of one of the four wall portions constituting the annular wall portion 13E. Specifically, the protruding portions 13B extend downward (in one direction) away from the closing portion 13A, of a surface direction of the closing wall portion 13D, in the flat plate shape. The plate thickness direction of the protruding portions 13B is the left-right direction. The plate width of a base end portion of each protruding portion 13B increases toward the annular wall portion 13E. The protruding portions 13B can be elastically deformed in the left-right direction. The leading end portions of the protruding portions 13B in the protruding direction extend in the direction opposite to the extending direction of the annular wall portion 13E, that is, rearward of a back surface 13J of the closing wall portion 13D. In other words, the protruding portions 13B are bent in an L-shape.

Each protruding portion 13B includes a supported portion 13F and a protrusion 13G. The supported portions 13F and the protrusions 13G protrude outward in the left-right direction from the respective protruding portions 13B. The protrusions 13G are respectively provided at the leading end portions of the protruding portions 13B. The supported portions 13F have a columnar shape whose axis extends in the left-right direction. The lower side of the leading end portion of each supported portion 13F in the projecting direction is inclined downwards and inwards in the left-right direction.

The protrusions 13G have a hemispherical shape. The diameter of the protrusions 13G is smaller than the diameter of the supported portions 13F. The protruding dimension of the protrusions 13G from the respective protruding portions 13B is smaller than the protruding dimension of the supported portions 13F. The protrusions 13G are respectively provided at the leading end portions of the protruding portions 13B in the projecting direction. The distance dimension between each supported portion 13F and the closing portion 13A is smaller

than the distance between each protrusion 13G and the closing portion 13A.

The pair of extending portions 13C are arranged side-by-side in the left-right direction between the pair of protruding portions 13B. The extending portions 13C extend in the flat plate shape in a direction along the closing wall portion 13D and away from the closing portion 13A. The plate thickness direction of the extending portions 13C is the left-right direction. For this reason, the extending portions 13C are elastically deformable in the left-right direction. A locking protrusion 13H protruding inward in the left-right direction is provided at the leading end of each extending portion 13C in the projecting direction.

Example of Procedure for Assembling Electrical Junction Box

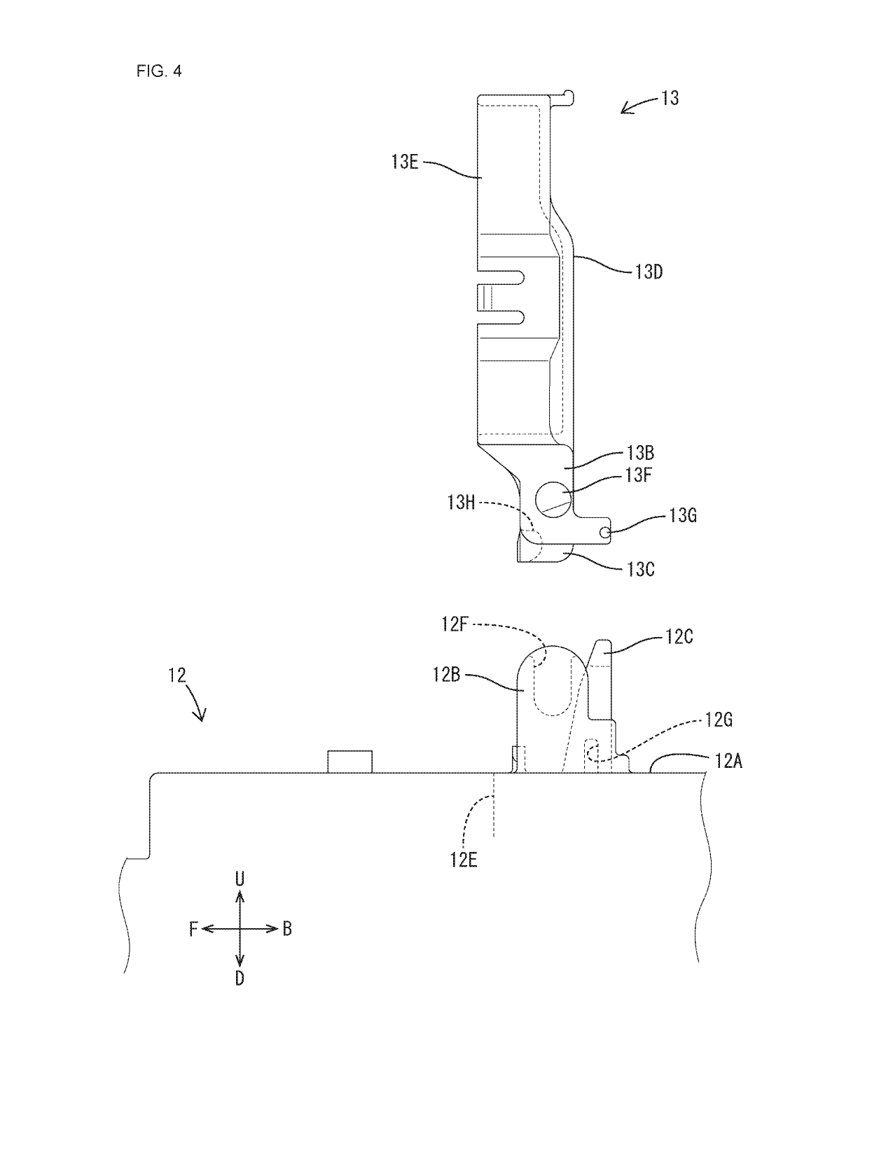

Next, an example of the assembling procedure of the electrical junction box 11 will be described. First, as shown in FIG. 4, the pair of protruding portions 13B and the pair of extending portions 13C are set to face the pedestal 12A of the base body 12. Furthermore, the direction in which the annular wall portion 13E extends from the closing wall portion 13D is directed toward the through hole 12E side, and the closing wall portion 13D is directed toward the back support portion 12C side. In this posture, the supported body 13 is brought close to the base body 12 from above.

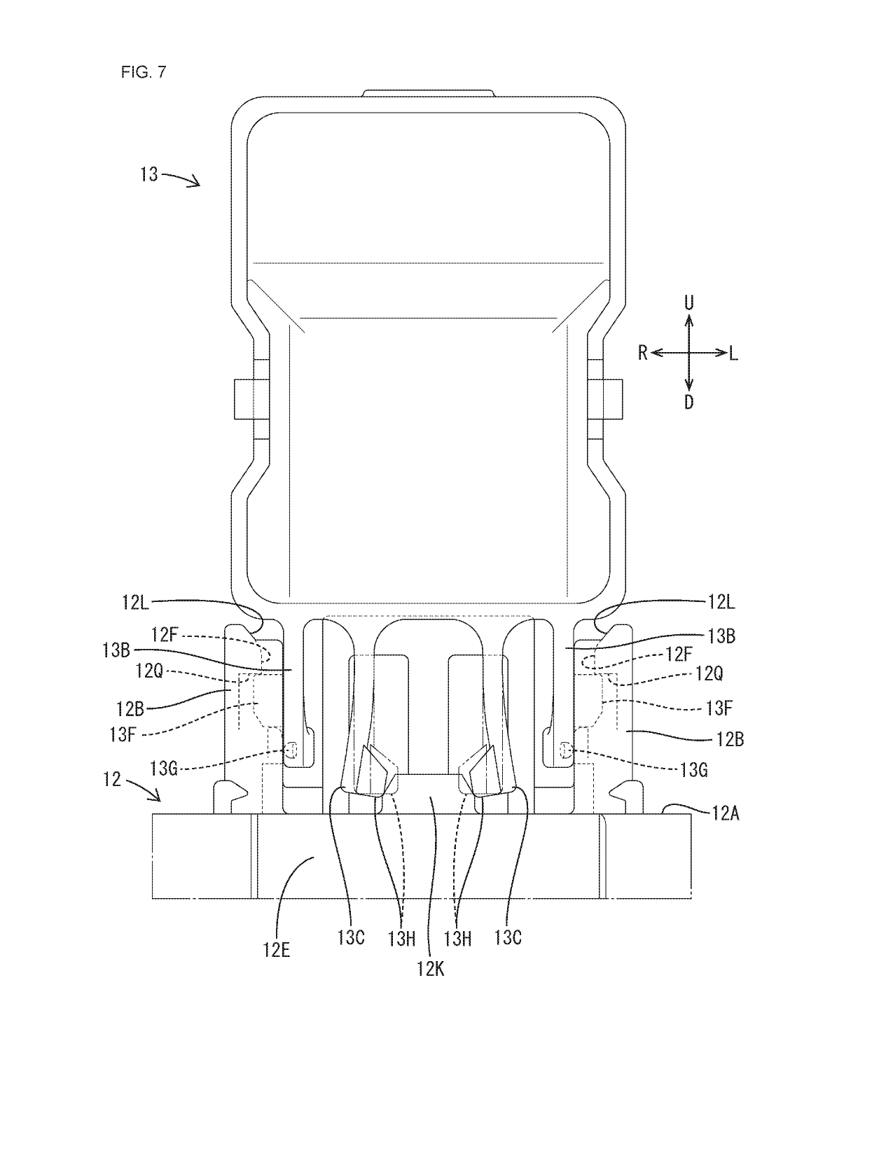

Next, the supported body 13 is brought further closer to the base body 12, while the outer surfaces of the pair of protruding portions 13B in the left-right direction extend along the inner surfaces of the pair of upright portions 12B in the left-right direction (see FIG. 7). By doing so, the supported portions 13F are pressed inward in the left-right direction by guiding surfaces 12L (see FIG. 7) respectively formed on the supporting portions 12F of the upright portions 12B, and the protruding portions 13B elastically deform inward in the left-right direction. When the supported portions 13F pass through the guiding surfaces 12L downward, the supported portions 13F fit into fitting recesses 12Q (see FIG. 7) formed below the guiding surfaces 12L, respectively, and at the same time, the base end portions (the protruding portions 13B of the portions in which the supported portions 13F are arranged) of the protruding portions 13B elastically return. Accordingly, the supported portions 13F of the protruding portions 13B are fitted to the supporting portions 12F of the upright portions 12B in a retained state (see

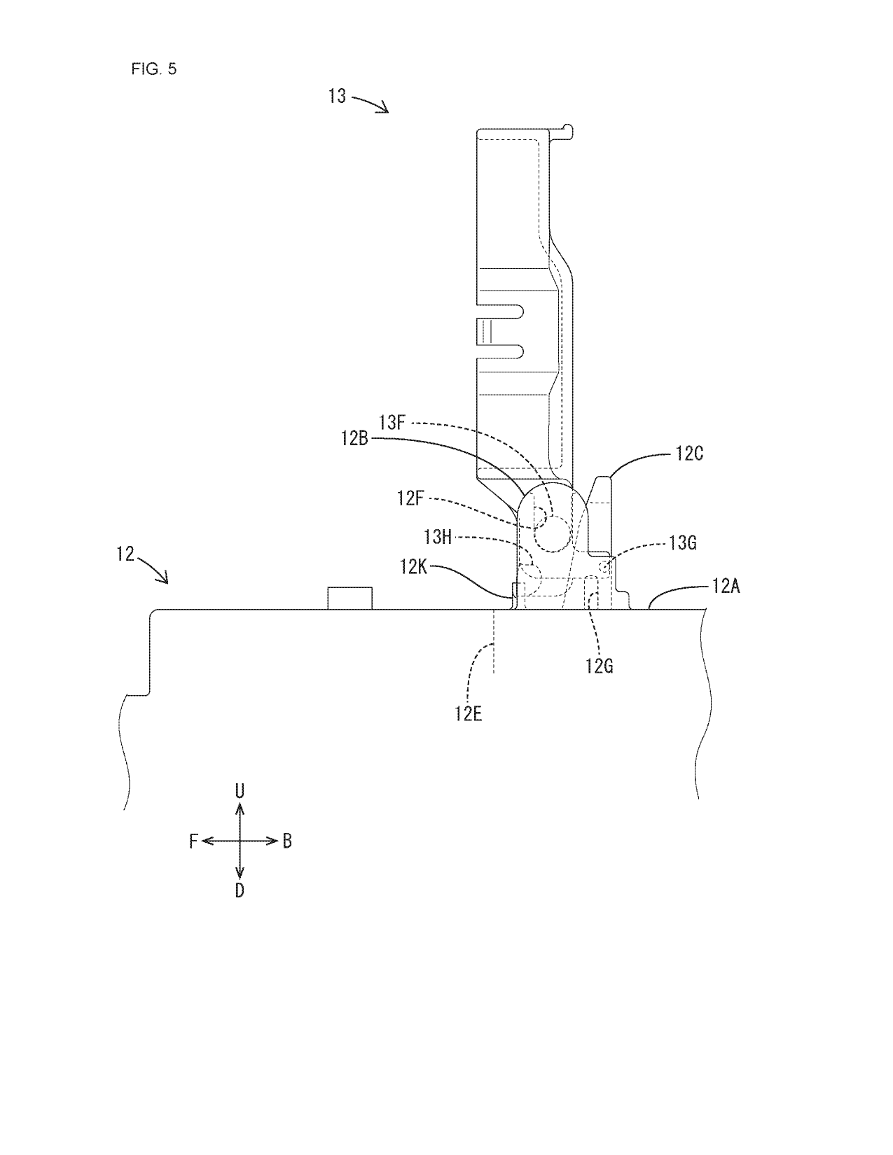

FIGS. 5 and 7), respectively. In this manner, the supporting portions 12F support the supported portions 13F.

Also, the protrusions 13G are pressed inward in the left-right direction by the inner surfaces of the upright portions 12B in the left-right direction, and slide downward on the inner surfaces of the upright portions 12B in the left-right direction. At this time, the leading end portions of the protruding portions 13B on which the protrusions 13G are arranged are elastically deformed inward in the left-right direction. The state of the supported body 13 shown in FIG. 5 does not correspond to the upright state in Embodiment 1 because the protrusions 13G have not been fitted into the recesses 12G.

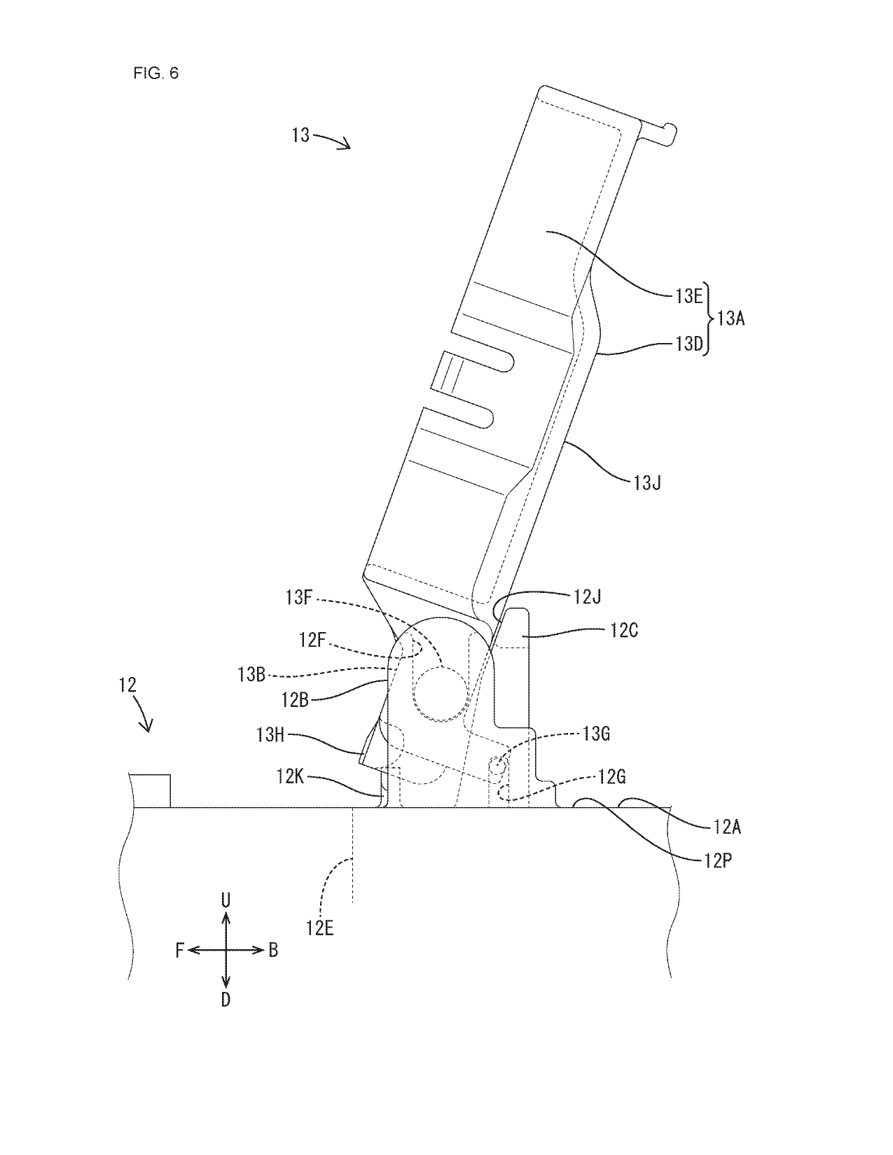

Next, as shown in FIG. 6, the closing portion 13A of the supported body 13 is rotated about the supported portion 13F in the direction away from the through hole 12E (rearward). By doing so, the protrusions 13G slide on the inward surfaces in the left-right direction of the upright portions 12B in a direction approaching the through hole 12E (forward). When the protrusions 13G reach the recesses 12G of the upright portions 12B, the protrusions 13G are fitted into the recesses 12G from the inner side in the left-right direction. The dimension of the recesses 12G in the front-rear direction is larger than the diameter of the protrusions 13G. At the same time, the leading end portions of the protruding portions 13B on which the protrusions 13G are disposed are elastically restored. At this time, the back surface 13J of the closing wall portion 13D comes into surface contact with the inclined surface 12J of the back support portion 12C. Also, the locking protrusions 13H are pressed outward in the left-right direction by the projecting portions 12K, and thus the extending portions 13C elastically deform outward in the left-right direction (see FIG. 7). When the locking protrusions 13H ride over the projecting portions 12K toward the through hole 12E side (forward), the extending portions 13C elastically return (see FIG. 7). At this time, the protrusions 13G are located below the back surface 13J of the closing wall portion 13D.

For example, when the back surface 13J of the closing wall portion 13D of each supported body 13 is pressed in a direction toward the through hole 12E (forward), the protrusions 13G come into contact with the rear edges of the recesses 12G. In other words, the protrusions 13G are fitted into the recesses 12G in the upright state and restrict rotation of

the supported body 13 from the upright state to the prone state. At the same time, the locking protrusions 13H come into contact with the projecting portions 12K from the front. In this manner, each supported body 13 is attached to the base body 12 in a state of being held in the upright state. The inclined surface 12J of each back support portion 12C is inclined along the back surface 13J of the supported body 13 in the upright state. Each back support portion 12C supports the back surface 13J of the supported body 13 in the upright state.

The back surface 13J of each supported body 13 in the upright state is disposed at an acute angle relative to a seating surface 12P of the pedestal 12A. In the front-rear direction, when each supported body 13 is in the upright state, the end (upper end) of the supported body 13 farthest from the base body 12 is located rearward of the back support portion 12C. Since each supported body 13 does not fall rearward due to the back support portion 12C, other components (another supported body 13 in this Embodiment 1) can be disposed in the space facing the back surface 13J of the supported body 13, thus making it possible to reduce the size of the structure in the region of the electrical junction box 11.

Next, the cover unit 10 is attached to the case 20 on which the electronic components such as relays and registers, bus bars and the like (not shown) have been attached. Specifically, the hanging wall portion 12D of the base body 12 is disposed such that the cover unit 10 is brought close to the case 20 from above and the peripheral wall portion 20B is covered from the outside (see FIG. 1). Then, elastic locking portions 12M provided on the hanging wall portion 12D are respectively locked to the locking claws 20C provided on the peripheral wall portion 20B, thus coupling the case 20 and the cover unit 10 to each other (see FIG. 1).

Then, bolts and the like (not shown) are fastened to the electronic components, bus bars, and the like housed in the case 20 via the through holes 12E. At this time, each supported body 13 is in a state of being more than 90 degrees from the prone state, and is held in the upright state that is inclined in a direction away from the through hole 12E (see FIG. 6). For this reason, it is easy to perform the operation via the through hole 12E.

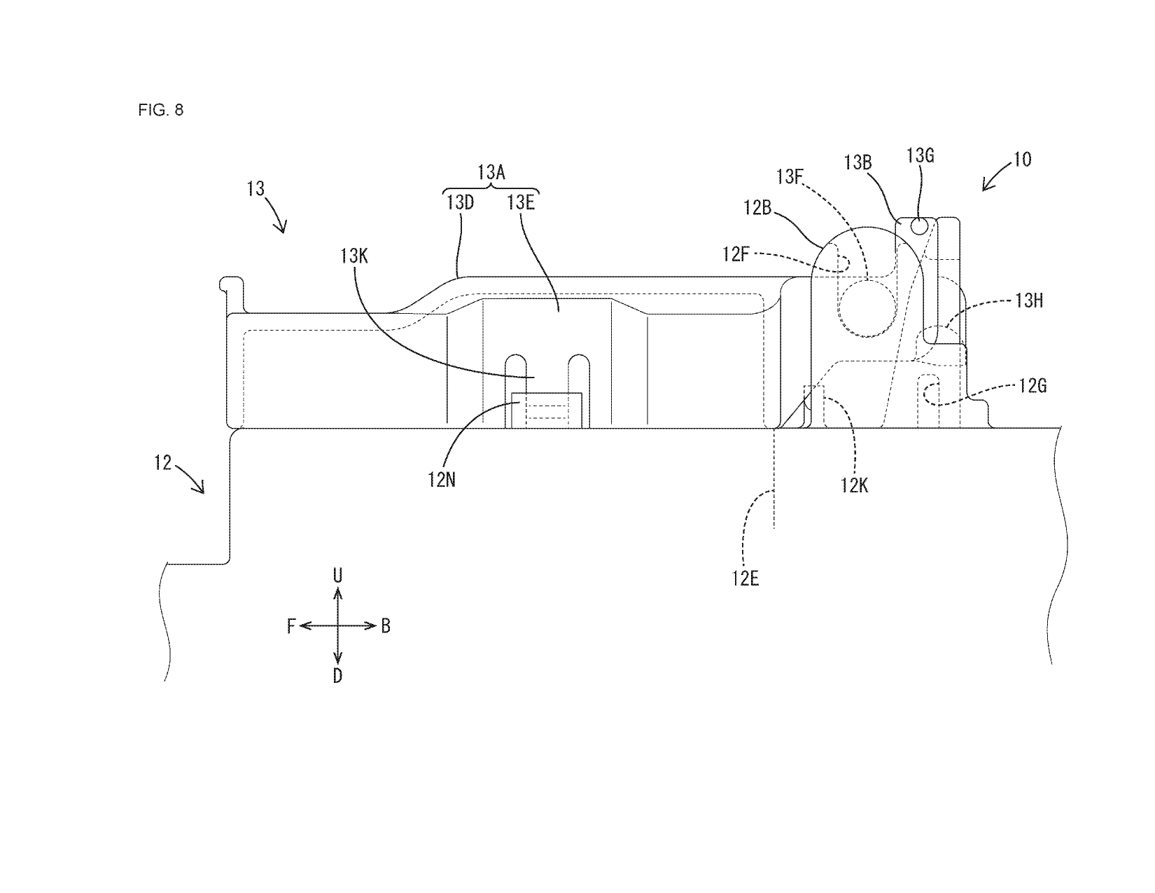

Then, as shown in FIG. 8, each through hole 12E is closed by turning the support body 13 from the upright state to the prone state. Specifically, the closing portion 13A of the supported body 13 is pressed in a direction approaching the through hole 12E (forward). The

protrusions 13G then disengage from the recesses 12G. At the same time, the leading end portions of the protruding portions 13B in the protruding direction elastically deform inward in the left-right direction, and the protrusions 13G slide on the surfaces of the upright portions 12B in the left-right direction in a direction away from the through hole 12E (rearward). In other words, the protrusions 13G are detachably locked to the recesses 12G. When the protrusions 13G reach positions separated from a space between the pair of upright portions 12B (rearward of the upright portions 12B), the protruding portions 13B elastically return to their original positions. In other words, when the protrusions 13G disengage from the recesses 12G, the supported body 13 changes from the upright state to the prone state.

At the same time, the locking protrusions 13H are pressed outward in the left-right direction by the projecting portions 12K, and thus the extending portions 13C elastically deform outward in the left-right direction (see FIG. 7). When the locking protrusions 13H pass through the projecting portions 12K in the direction (rearward direction) away from the through hole 12E, the elastic restoring force of the extending portions 13C is converted into rotating force which rotates the closing portion 13A about the supported portions 13F toward the through hole 12E. Accordingly, the closing portion 13A is biased in a direction toward the through hole 12E (forward) and rotates about the supported portion 13F, and closes the through hole 12E from above. At this time, the locking projections 13K provided on the closing portion 13A are locked to the locking projections 12N provided on the base body 12. In this manner, the supported bodies 13 are held in the prone state relative to the base body 12. That is, each supported body 13 is coupled to the base body 12 so as to be rotatable about the supported portion 13F in the upright state and prone state.

As described above, the cover unit 10 according to Embodiment 1 includes the base body 12 and the supported bodies 13. The supported bodies 13 each have the supported portions 13F and can be rotated about the supported portions 13F between the upright state and the prone state relative to the base body 12. Each supported body 13 is provided with the protrusions 13G, and the base body 12 is provided with the recesses 12G for restricting rotation of the supported body 13 from the upright state to the prone state by fitting the protrusions 13G thereto in the upright state. In this manner, a configuration can be achieved in which, rotation

of the supported body 13 from the upright state to the prone state can be suppressed due to the protrusions 13G being fitted into the recesses 12G, and the supported body 13 can be changed to the prone state by disengaging the protrusions 13G from the recesses 12G. Here, the "upright state" refers to a state where the protruding portions 13G are fitted into the recesses 12G and the supported body 13 rises upward from the base body 12, and the "prone state" refers to a state where the supported body 13 lies along the pedestal 12A (upper surface) of the base body 12.

The base body 12 includes the pedestal 12A, the upright portions 12B protruding from the pedestal 12A, and the supporting portions 12F respectively provided on the upright portions 12B and supporting the supported portions 13F. The recesses 12G provided in the base body 12 are located between the supporting portions 12F and the pedestal 12A in the projecting direction of the upright portion 12B. With this configuration, it is possible to prevent the recesses 12G and the protrusions 13G from being positioned away from the pedestal 12A in the projecting direction of the upright portions 12B, making it easy to reduce the size of the configuration.

In the upright state, each supported body 13 is open by more than 90 degrees from its prone state, and the back surface 13J of the supported body 13 is disposed at an acute angle with respect to the seating surface 12P of the pedestal 12A. The base body 12 includes the back support portion 12C that supports the back surface 13J of the supported body 13 in the upright state. With this configuration, it is easy to stably hold the posture of the supported body 13 in the upright state with the back support portion 12C.

The back support portion 12C has the inclined surface 12J that is inclined along the back surface 13J of the supported body 13 in the upright state. With this configuration, the back support portion 12C can come into surface contact with the back surface 13J of the supported body 13, and stress generated when coming into contact with the back surface 13J can be dispersed on the inclined surfaces 12J.

The supported body 13 includes an elastically deformable protruding portion 13B that extends in one direction. The protrusions 13G are provided at the leading end portions of the protruding portions 13B in the one direction, and are detachably locked to the recesses 12G.

With this configuration, the protruding portions 13B can be elastically deformed, and the protrusions 13G are provided at the leading end portions in the protruding direction, thus making it easy for the protrusions 13G and the recesses 12G to smoothly fit to and separate from each other.

Other Embodiments of Present Disclosure

Embodiment 1 disclosed herein is an example in all respects, and is not to be construed as limiting.

The shape of the opening of the through hole is not limited to that of the above embodiments.

Different from the above embodiments, the protruding portions may be provided in the upright portions of the base body, and the recesses may be provided in the protruding portions of the supported bodies. In this case, it is conceivable to provide the protruding portions between the supporting portions and the pedestal in the protruding direction of the upright portion. That is, it is sufficient if protruding portions are provided on either the supported bodies and the base body and a recess is provided on the other of the supported bodies and the base body.

The cover unit according to the present disclosure may also be applied to box bodies other than the electrical junction box.

Different from the above embodiment, the supported body and the base portion may be integrally formed by molding, and the supported portions may be configured as hinges that are continuous with the supported bodies and the base portion.

A configuration is also possible in which, in the supported bodies in an upright state in which the protruding portions are fitted into the recesses and rise upward from the base body, the back surfaces of the supported bodies are disposed at a right angle to the seat surface of the pedestal.

What is claimed is:

1. A cover unit comprising: a base body; and a supported body, wherein the supported body has a supported portion and is rotatable about the supported portion between an upright state and a prone state relative to the base body, and one of the supported body and the base body is provided with a protrusion, and the other of the supported body and the base body is provided with a recess that restricts rotation of the supported body from the upright state to the prone state by fitting the protrusion therein in the upright state.

2. The cover unit according to claim 1, wherein the base body includes: a pedestal; an upright portion protruding from the pedestal; and a supporting portion that is provided at the upright portion and supports the supported portion, and the one of the recess and the protrusion that is provided on the base body is provided between the supporting portion and the pedestal in a direction in which the upright portion protrudes.

3. The cover unit according to claim 2, wherein the supported body in the upright state is open more than 90 degrees from the prone state, and a back surface of the supported body is disposed at an acute angle relative to a seat surface of the pedestal, and the base body includes a back support portion that supports the back surface of the supported body in the upright state.

4. The cover unit according to claim 3, wherein the back support portion has an inclined surface that is inclined along the back surface of the supported body in the upright state.

5. The cover unit according to claim 1, wherein the supported body includes a protruding portion that extends in one direction and is capable of elastically deforming, and the protrusion is provided at a leading end portion in the one direction of the protruding portion, and is detachably locked to the recess.
